(19) United States
(12) Patent Application Publication
(10) Pub. No.: US 2010/0324192 A1
(43) Pub. Date: Dec. 23, 2010

(54) Method for the Production of Flameproofed Fiber Composite Materials or Prepregs

(76) Inventor: Herbert Costard, Neu Wulmstorf (DE)

Correspondence Address: ROBERTS & ROBERTS, LLP;ATTORNEYS AT LAW, P.O. BOX 484, PRINCETON, NJ, 08542-0484, US

(21) Appl. No.: 12/446,080

(22) PCT Filed: Nov. 12, 2007
(86) PCT No.: PCT/EP07/62200

§ 371 Date: Apr. 17, 2009

(30) Foreign Application Priority Data
Nov. 15, 2006 (DE) 10 2006 054 123.5
Apr. 4, 2007 (DE) 10 2007 016 698.4

(51) Int. Cl. C08K 3/22

(52) U.S. Cl. 524/437

(57) ABSTRACT

The invention relates to an optimized method for improving the flameproofing of fiber composite materials or prepregs, particularly for the production of thermosets. An upper limit already exists on the percentage increase in flameproofing agent for glass fiber composites. However, the application of natural fibers in the composite increases the demands placed on the flameproofing. Thus the problem addressed by this invention is to offer a new method for the flameproofing of natural fiber composites and composites with increased flameproofing, and for the flameproofing of conventional fiber composites, which avoids the disadvantages of known methods which are created by increasing the viscosity of the polymer with flameproofing agent. Furthermore, a flameproofed composite should be offered, which avoids the disadvantages of known fiber composites which are created by increasing the viscosity of the polymer with flameproofing agent. The problem is solved, in addition to a device according to the invention, in that during the production of flameproofed fiber composite materials containing fiber material embedded in polymer, a cover layer is constructed containing flameproofing agent in the area of at least one surface area of the fiber composite materials.

### TECHNICAL FIELD

The invention relates to an optimized method for improving the flame-proofing of composite fiber materials or prepregs, in particular for producing thermosetting plastic materials. However, it can also be employed in connection with the production of flame-proofed thermoplastic materials, or respectively mixtures of thermoplastic and thermosetting plastic materials.

### PRIOR ART

These composite fiber materials are produced from semi-finished fiber materials, such as fleeces, woven materials, layments or rovings, for example, containing glass fibers, carbon fibers, synthetic fibers or natural fibers, such as cotton, flax or hemp, for example (Literature: Flemming, Ziegmann, Roth: Faserverbundbauweisen [Composite Fiber Structures], Berlin 1995), embedded in a polymeric matrix system.

Prepregs are formed from monomers intended for polymerization and semi-finished fiber materials embedded therein, as well as further additives. They are semi-finished materials which can be processed by machinery. By using prepregs it is possible to achieve an even and high quality. Short turnover times are possible because of curing under high temperatures.

Unsaturated polyester resins, epoxide resins and phenolic resins are preponderantly employed as the polymeric matrix systems, lately also resin systems on the basis of natural oils. Furthermore, multi-component materials (polymer mixtures) are in use in order to match the technical and chemical properties to the respective application. All these materials will be combined under the term polymer in what follows.

It is possible to mix additives with the plastic materials as processing aids and for changing their properties, such as emulsifiers and catalysts, for example.

Often further additives are employed in connection with thermosetting, but also with thermoplastic materials. They are used as extenders in order to save resin, for improving the surface quality, for reducing brittleness and for increasing stiffness, as well as possibly for increasing the resistance to flame (Literature: Hellerich, Harsche, Haenle: Werkstoff-Führer Kunststoffe [Guide to Materials, Plastics], Munich 2001). The amount to which these additives are employed is limited, because a defined viscosity cannot be downwardly exceeded when introducing the polymer into the semi-finished material, since otherwise an even penetration of the composite fibers is not possible, so that the sturdiness of the composite fiber material would be rapidly reduced. Moreover, the addition of such materials limits the percentile proportion of the polymer, because of which a lowering of the sturdiness of the composite fiber material takes place.

For example, aluminum hydroxide Al(OH)₃, halogen-splitting or phosphorous-containing products are employed as flame-proofing means admixed with the polymer matrix, or respectively with the monomer provided for polymerization, or with the molten thermoplastic material. For environmental protection purposes, the halogen-containing products have been replaced by newer, more expensive, but less effective products. Under the action of temperature, aluminum hydroxide releases water, or respectively steam, through reaction with the combustible substances the phosphorous-containing products form composites consisting of non-combustible gases. Flame-proofing materials introduced into the polymer often negatively affect the physical properties of the plastic materials and in many ways have a negative effect on their processing.

Additional requirements for flame-proofing result when employing natural fibers in the composite material, because the natural fibers are combustible substances, substantially cellulose materials. It is therefore necessary to broaden the flame-proofing, in particular to extend it to the appropriate treatment of the fibers. In contrast thereto, in connection with composite glass fiber materials, the flame-proofing material only has the job of regulating, or respectively reducing, the combustion behavior of the plastic material.

As explained above, a limit has already been set to a percentile increase of the flame-proofing material in the polymer matrix.

With a mass of equal weight, natural fibers have a higher fiber density in the semi-finished fiber material at a similar volume because of their lesser specific weight. Therefore, in contrast to semi-finished glass fiber material, the penetration of the liquid polymer when employing natural fibers requires a reduced viscosity of the polymer. Semi-finished glass fiber materials are flat drawn filaments, which result in an open semi-finished natural fiber material. Semi-finished natural fiber materials are plant cells and bundles of plant cells, which are partially connected at the center lamellas and with each other by OH-groups. The polymer must be able to enter into this structure in order to achieve a satisfactory fiber-matrix adhesion. Because of the increase in viscosity, narrow limits are therefore set to the introduction of additives, and thus also of flame-proofing materials, into the polymer, in particular in connection with natural fibers, by means of the conventional method of introducing flame-proofing materials into the polymer. Therefore this method is not suited to flame-proofing measures with an increased flame-proofing requirement, such as, for example, in connection with natural fiber prepregs or flame-sensitive polymers.

### REPRESENTATION OF THE INVENTION

It is therefore the object of the invention to disclose a novel method for the flame-proofing of composite natural fiber materials and composite materials with increased flame-proofing requirements, as well as for flame-proofing of conventional composite fiber materials, which avoids the disadvantages in the known methods created by the increase in viscosity of the polymer caused by the flame-proofing material. It is furthermore intended to disclose a flame-proofing composite material which avoids the disadvantages of the known composite fiber materials created by the increase in viscosity of the polymer caused by the flame-proofing material.

In accordance with the invention, this object is attained by a method in accordance with claim 1, or respectively by a composite material in accordance with claim 10. Dependent claims 2 to 9, as well as 11 and 12, disclose advantageous further developments.

Regarding the method, the object is attained in accordance with the invention, in which in the course of producing flame-protected composite fiber materials, which contain fiber material embedded in the polymer, a cover layer containing a flame-proofing material is formed in the area of at least one surface of the composite fiber material.

Surprisingly, and counter to the opinion generally advocated among experts that sufficient flame-proofing could only be achieved by means of an at least complete saturation of the composite fiber material with flame-proofing material, it is possible by means of the method in accordance with the invention to achieve flame-proofing, which also meets increased demands for flame-proofing, by the application of a cover layer constituting an essential flame-proofing. Such a cover layer can also be applied later.

Here the polymer used for embedding the fiber material, or respectively the monomer intended for polymerization, and/or the melted thermoplastic material, can also contain property-changing additives. Such additives can also have a flame-proofing effect. However, it should be noted here that the substantial concentration of the flame-proofing material resides in the cover layer.

The difference between composite natural fiber materials (NFC) and, for example, composite glass fiber materials (GFC), lies in the basically different adhesive properties of the polymer to the fibers. In connection with GFC, a surface adhesion takes place, which is achieved, for example, by the use of PVA as the polymer, while in connection with NFC an adhesion via free OH— groups on and in the cell structure makes the connection with the polymer possible. For this reason a “saturation” of the fiber material with the polymer used for embedding is necessary.

Therefore polymers without, or with only a small proportion of the flame-proofing means required as a whole, and other additives, are used, in particular with NFC, in order to be able to set the viscosity in such a way that the “saturation” of the fibers is assured, i.e. that a uniform wetting of the fibers with the polymer can take place.

Therefore the method in accordance with the invention is particularly advantageous in connection with the use of composite natural fiber materials, but can also be applied to all other composite fiber materials, for example composite glass fiber materials. It is possible in this way to also equip conventional composite fiber materials in such a way that they meet increased flame-proofing requirements, without having to expect a loss of sturdiness of the composite fiber materials. This means that composite fiber materials which, at present, can meet increased flame-proofing requirements only at the price of their stability, or even not at all, can now be equipped with additional surface flame-proofing, and can therefore also be used in connection with increased flame-proofing requirements.

By employing a method in accordance with the invention it is possible, depending on the conditions of use, to clearly reduce the concentration of flame-proofing materials which must be provided for embedding in the polymer, or it is respectively possible to completely omit the use of flame-proofing material in the polymer used for embedding (see claim 5). By means of this it is possible to achieve a viscosity which is reduced over what would be possible in connection with customary methods with an equally strong flame-proofing finish. It is thus possible, in particular in connection with natural fibers, to achieve an improved saturation of the fibers and/or an improved connection between the polymer and the fibers. This makes it possible to produce composite fiber materials with a greater flame-proofing effect, along with the same stability, or respectively greater stability, with the identical flame-proofing properties.

In accordance with the invention, the flame-proofing material is located for the greatest part on the surface of the composite fiber material and therefore has a considerably more active effect in case of fire in contrast to the method of the complete introduction of the flame-proofing material into the polymer, in which only a point-like release of the flame-reducing material, for example water, or respectively water vapor, takes place when employing aluminum hydroxide, depending on the amount per mass of the flame-proofing material in the polymer.

In accordance with the invention it is also possible to apply further layers, such as for example of lacquer and/or foil, over the cover layers constituting a fire protection, for example of aluminum hydroxide enclosed in polymer (see claim 4). Here, the cover layer should be understood to be a layer protecting the composite fiber material located under it against fire, i.e. a layer covering it.

It is particularly advantageous to apply the flame-proofing materials constituting the cover layer in accordance with claim 2 to the composite fiber material prior to the time at which the polymer used for embedding, or respectively the molten thermoplastic material has been completely cured. By means of this it is possible to bind the flame-proofing material on, or respectively in an area near the surface of the composite fiber material. It is particularly advantageous to roll-in the flame-proofing material following the application, but prior to the complete curing of the polymer used for embedding, or respectively of the molten thermoplastic material or, in connection with prepregs, to press it into the composite material during pressing and polymerization in the tool, and to enclose it in the polymer.

The technical production of prepregs preferably takes place in the known prepreg or SMC installations with the addition of a scattering or brushing device for aluminum hydroxide, for an aluminum hydroxide dispersion, or for a polymer which has been provided with a high percentage of aluminum hydroxide. When using fleeces, in particular thin fleeces, compacting of the fleeces by means of a water jet should be first performed for increasing the breaking length and for improving the draping capability of the fleeces, and therefore of the prepregs.

In accordance with claim 3, the flame-proofing material can act as a curing agent.

In accordance with dependent claim 6, prior to being embedded in the polymer, or respectively in the molten thermoplastic material, or in the monomer intended for polymerization, the fiber material can be provided with flame-proofing material by means of soaking, spraying, coating or other methods. As provided within the framework of this invention, this process can be combined with a flame-proofing finish in accordance with claim 1, but does not absolutely require flame-proofing in accordance with claim 1 and can, considered by itself, constitute a (separate) invention standing on its own. In accordance with this, flame-proofing can also be achieved by itself, or at least to a preponderant extent, by equipping the fiber material with flame-proofing material, for example by soaking, spraying, coating or the like, of the fiber material. Thus, a composite fiber material which is flame-proofed in accordance with this separate invention can consist of fiber material equipped with flame-proofing material, which has been embedded in a polymer, a monomer intended for polymerization, and/or molten thermoplastic material. In this case the polymer, the monomer intended for polymerization, and/or the molten thermoplastic material can be equipped with additional flame-proofing material, or can be free of the latter. Furthermore, the composite fiber material can be provided with a layer of flame-proofing material on its surface, but does not absolutely depend on it, depending on the demands for flame-proofing.

The amount of flame-proofing material applied to the fibers or introduced into them can be varied in such a way that, depending on the type of polymer and the application, only a small amount or no flame-proofing material needs to be mixed into the polymer used for embedding.

The flame-proofing material applied to the fibers (in particular natural fibers) has been selected in accordance with the invention in such a way that in particular it makes it possible for the subsequently applied polymer to penetrate through the flame-proofing material as far as on, or respectively into, the fibers in order to make possible good fiber/matrix adhesion, or respectively not to cause a noticeable reduction of the total sturdiness of the composite material because of the flame-proofing material applied to the fibers.

In the course of soaking, the fibers are equipped with a flame-proofing material applied in liquid form, for example an aqueous phosphorous dispersion in accordance with dependent claim 8, and are dried prior to the application of the polymer.

In the case of multi-layer, for example ten layer composite fiber materials, the outer layers are supplied in accordance with the invention with a high proportion of flame-proofing material, for example Al(OH)₃, in order to achieve the desired flame-proofing effect without substantially negatively affecting the total sturdiness. In this case these outer layers can be produced with or without fibers.

In accordance with claim 10, the object is also attained by a flame-proof composite fiber material or prepreg, containing fiber material embedded in polymer, in which the concentration of at least one flame-proofing material is higher in at least a surface than the average in the remainder of the composite material, or respectively at least rises at least to the surface.

In particular, a layer has been worked into the area of a surface, i.e. on the surface and/or worked into the surface of the composite fiber material, having a concentration of the flame-proofing material which is increased in comparison with the remainder of the composite fiber material. The increase of the concentration of the flame-proofing material can be designed to be continuous or in jumps.

### Way(s) for Executing the Invention

Further advantages and characteristics of the invention ensue from the following description of non-limiting exemplary embodiments.

As a basis for comparison, a paper fleece, which was soaked in flame-proofing material (Flavacon GP with an active ingredient concentration of 15%, Schill+Seilacher AG) provided in an aqueous solution and subsequently dried, consisting of 100% cotton linters of a basis weight of 180 g/m² and a thickness of 0.5 mm, was embedded in phenol resin (Bakelite PHL 2485, Hexion Speciality Chemicals GmbH). The proportion of fiber mass in the created prepreg (honeycomb sandwich 3.7 mm, with Nomex honeycomb 3.00 mm, EURO Composites) amounted to approximately 50 weight-%. The burn test showed the following values as the result:
Burn length 60 s, vertically 120 mm
Burn length 12 s, vertically 22 mm
Heat release peak 5 min, 78 kW/m²
Heat release 2 min, 77 kW/m².

In connection with an otherwise identical prepreg preparation, aluminum hydroxide was applied by sprinkling it on the surface of the paper fleece which had been soaked in polymer. It adheres loosely to the surface of the uncured polymer. Enclosing of the flame-proofing material in the polymer takes place by means of the subsequent rolling-in of the aluminum hydroxide and the fixation of the material in the surface of the prepreg. This operation did not result in losses of sturdiness. Depending on the amounts applied, 10 to 80% of aluminum hydroxide were present, bonded with the polymer, at the surface of the composite. In relation to the total mass, this corresponds to a proportion of aluminum hydroxide of approximately 1 to 20 weight-%. The burn test showed the following values as the result:
Burn length 60 s, vertically 110 mm
Burn length 12 s, vertically 13 mm
Heat release peak 5 min, 46 kW/m²
Heat release 2 min, 61 kW/m².

Alternatively, wet fleece of 100% bleached flax of a fiber length of 15 mm and a basis weight of 180 g/m² and a thickness of 0.5 mm and provided with flame-proofing material (Flavacon GP with an active ingredient concentration of 15%, Schill+Seilacher AG) was, for example, embedded in phenol resin (Bakelite PHL 2485, Hexion Speciality Chemicals GmbH). Aluminum hydroxide was embedded into the surface of the polymer. The proportion of fiber mass in the created prepreg (honeycomb sandwich 3.7 mm, with Nomex honeycomb 3.00 mm, EURO Composites) amounted to approximately 50 weight-%. The burn test showed the following values as the result:
Burn length 60 s, vertically 112 mm
Burn length 12 s, vertically 14 mm
Heat release peak 5 min, 47 kW/m²
Heat release 2 min, 60 kW/m².

Further tests were performed with modified composite fiber materials as follows:

Glass fabric 7781, basis weight 296 g/cm², thickness 0.4 mm, proportion of fiber mass in the prepreg approximately 65 weight-%, no aluminum hydroxide on the prepreg surface,
Burn length 60 s, vertically 101 mm
Burn length 12 s, vertically 15 mm
Heat release peak 5 min, 19 kW/m²
Heat release 2 min, 15 kW/m².

Glass fabric 7781, basis weight 296 g/cm², thickness 0.4 mm, proportion of fiber mass in the prepreg approximately 65 weight-%, with aluminum hydroxide on the prepreg surface (see above),
Burn length 60 s, vertically 90 mm
Burn length 12 s, vertically 11 mm
Heat release peak 5 min, 16 kW/m²
Heat release 2 min, 12 kW/m².

1. A method for producing flame-proofed composite fiber materials, which composite fiber materials contain a fiber material embedded in at least one polymer, or a non-polymerized monomer, comprising forming a cover layer on at least one surface of the composite fiber material, which cover layer contains at least one flame-proofing material.

2. The method in accordance with claim 1, wherein the cover layer containing the flame-proofing material is formed on the at least one surface before the at least one polymer is completely cured, or before the monomer is polymerized.

3. The method in accordance with claim 1 wherein the flame-proofing material simultaneously acts as a curing agent.

4. The method in accordance with claim 1 wherein aluminum hydroxide comprises the flame-proofing material.

5. The method in accordance with claim 1 wherein no flame-proofing materials are admixed with the monomer or to the at least one polymer, prior to embedding the fibers.

6. The method in accordance with claim 1 wherein prior to being embedded in the monomer or to the at least one polymer, the fiber material is provided with a flame-proofing material.

7. The method in accordance with claim 6, the fiber material is provided with the flame-proofing material by means of soaking, spraying, or coating with an aqueous or alcohol solution, or an organic solvent solution or dispersion of the flame-proofing material.

8. The method in accordance with claim 1 wherein the flame-proofing material comprises phosphorous.

9. The method in accordance with claim 6, wherein the flame-proofing material is suitable for textiles.

10. A flame-proofed composite fiber material comprising a composite fiber material containing fiber material embedded in at least one polymer, or non-polymerized monomer and at least one flame-proofing material, wherein a concentration of the at least one flame-proofing material is higher in the area of at least a surface of the composite fiber material than an average concentration of the at least one flame-proofing material in a remainder of the composite fiber material, or respectively at least rises toward the surface.

11. The flame-proofed composite fiber material in accordance with claim 10, wherein at least one surface the composite fiber material has a higher concentration of the flame-proofing material than the average concentration of the flame-proofing material in the remainder of the composite material.

12. The flame-proofed composite fiber material in accordance with claim 11, comprising at least one cover layer which comprises aluminum hydroxide.
